(19) United States
(12) Patent Application Publication
(10) Pub. No.: US 2026/0267441 A1
(43) Pub. Date: Sep. 10, 2026

(54) TOUCH DETECTION MODULE, DISPLAY DEVICE INCLUDING THE SAME, AND ELECTRONIC DEVICE INCLUDING THE SAME

(71) Applicant: Samsung Display Co., Ltd., Yongin-Si (KR)

(72) Inventors: Ji Yeong LEE, Yongin-si (KR); Min Hong KIM, Yongin-si (KR)

(21) Appl. No.: 19/378,325

(22) Filed: Nov. 4, 2025

(30) Foreign Application Priority Data
Mar. 4, 2025 (KR) 10-2025-0027568
Apr. 17, 2025 (KR) 10-2025-0050092

(51) Int. Cl. G06F 3/041; G06F 3/044

(52) U.S. Cl. CPC G06F 3/0418; G06F 3/0412; G06F 3/044; G06F 2203/04112

(57) ABSTRACT

The present disclosure relates to a touch detection module, a display device including the same, and an electronic device including the same. According to an embodiment of the disclosure, a touch sensing module comprising a touch sensing unit in which touch electrodes are arranged in a touch sensing area, and a touch driving circuit driving the touch electrodes during the touch sensing period to detect a touch input position and generate and output a touch position coordinate data, wherein the touch driving circuit drives the touch electrodes during a preset detection period to detect touch sensing signals, generates sensitivity compensation data for each touch node to compensate for magnitude deviation of the touch sensing signals, and supplies a voltage magnitude of touch driving voltages for each touch electrode according to a compensation value of the sensitivity compensation data during the touch sensing period.

### CROSS-REFERENCE TO RELATED APPLICATION

This application claims priority from Korean Patent Application No. 10-2025-0027568 filed on March 4, 2025 and Korean Patent Application No. 10-2025-0050092 filed on April 17, 2025 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a touch detection module, a display device including the same, and an electronic device including the same.

### 2. Description of the Related Art

In today’s information-oriented society, more and more demands are placed on display devices for displaying images in various ways. For example, the display devices have been applied to various electronic devices, such as a smart phone, a digital camera, a laptop computer, a navigation system, and a smart television.

The display device may be a flat panel display device such as a liquid crystal display device, a field emission display device and an organic light emitting display device. Among the flat panel display devices, in the light emitting display device, since each pixel of a display panel includes a light emitting element capable of emitting light, an image can be displayed without a backlight unit providing light to the display panel.

Recently, the display device includes a touch sensing module for sensing a touch as one of input interface modules. The touch sensing module includes a touch sensing unit in which touch electrodes are arranged, and a touch driving circuit detecting the amount of charge in capacitance between the touch electrodes. The touch sensing unit may be formed in a shape mounted on an image display unit of a display device or may be integrally formed with the image display unit. In the case where a touch sensing unit is formed integrally with the image display unit, the display device may be slimmer.

### SUMMARY

Aspects of the present disclosure provide a touch sensing module capable of detecting and compensating touch sensitivity deviation of channels and touch nodes by detecting touch sensing signals and sensing data of a touch sensing unit in a preset detection period and comparing and analyzing the sensing data, and a display device and an electronic device including the same.

Aspects of the present disclosure also provide a touch sensing module capable of compensating and driving to minimize a touch sensitivity deviation of channels and touch nodes by comparing and analyzing an average value analysis data of sensing data for each touch node or peak data of adjacent other touch nodes, and a display device and an electronic device including the same.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an embodiment of the disclosure, a touch sensing module comprising a touch sensing unit in which touch electrodes are arranged in a touch sensing area, and a touch driving circuit driving the touch electrodes during a touch sensing period to detect a touch input position and generate and output a touch position coordinate data, wherein the touch driving circuit drives the touch electrodes during a preset detection period to detect touch sensing signals, and generates sensitivity compensation data for each touch node to compensate for magnitude deviation of the touch sensing signals, and supplies a voltage magnitude of touch driving voltages for each touch electrode according to a compensation value of the sensitivity compensation data during the touch sensing period.

According to an embodiment of the disclosure, a display device comprising a display panel comprising display area in which a plurality of sub-pixels are arranged, and a touch sensing module located on the front surface of the display panel to sense a touch, wherein the touch sensing module comprises a touch sensing unit in which touch electrodes are arranged in a touch sensing area, and a touch driving circuit driving the touch electrodes during the touch sensing period to detect a touch input position and generate and output a touch position coordinate data, wherein the touch driving circuit drives the touch electrodes for the preset detection period to detect touch sensing signals, and generates sensitivity compensation data to compensate for magnitude deviation of the touch sensing signals for each touch node, and supplies a voltage magnitude of touch driving voltages for each touch electrode according to a compensation value of the sensitivity compensation data during the touch sensing period.

According to an embodiment of the disclosure, an electronic device comprising a display device displaying an image, an image signal processor controlling an image display timing of the display device, and a power module providing a power signal to the display device, wherein the display device comprises a display panel comprising display area in which a plurality of sub-pixels are arranged, and a touch sensing module located on the front surface of the display panel to sense a touch, wherein the touch driving circuit comprises a touch sensing unit in which touch electrodes are arranged in a touch sensing area, and a touch driving circuit driving the touch electrodes during a touch sensing period to detect a touch input position and generate and output a touch position coordinate data, wherein the touch driving circuit drives the touch electrodes during a preset detection period to detect touch sensing signals, and generates sensitivity compensation data for each touch node to compensate for magnitude deviation of the touch sensing signals, and supplies a voltage magnitude of touch driving voltages for each touch electrode according to a compensation value of the sensitivity compensation data during the touch sensing period.

The touch detection module, the display device, and the electronic device including the same according to the embodiments of the present disclosure may detect and compensate touch sensitivity deviation of the touch nodes and channels that changes due to a configurational change according to a corrosion or a deformation of touch wires or touch electrodes, thereby preventing touch detection failure and increase reliability.

In addition, touch detection module, the display device, and the electronic device including the same according to the embodiments of the present disclosure may compensate for deviation of a touch driving signal and sense a touch to minimize a touch sensitivity deviation of channels and touch nodes, thereby maintaining or further improving a touch sensing performance.

However, the effects of the embodiments are not restricted to the one set forth herein. The above and other effects of the embodiments will become more apparent to one of daily skill in the art to which the embodiments pertain by referencing the claims.

### BRIEF DESCRIPTION OF THE DRAWINGS

The above and other aspects and features of the present disclosure will become more apparent by describing in detail embodiments thereof with reference to the attached drawings, in which:

FIG. 1 is a perspective view illustrating a display device according to one embodiment of the present disclosure;

FIG. 2 is a plan view illustrating a display device according to one embodiment;

FIG. 3 is a side view illustrating a display device according to one embodiment;

FIG. 4 is a layout view schematically illustrating an example of a layout of the display panel shown in FIGS. 1 to 3;

FIG. 5 is a layout view schematically illustrating an example of a touch sensing module shown in FIG. 3;

FIG. 6 is an enlarged plan view illustrating an example of a touch node shown in FIG. 5 in detail;

FIG. 7 is a block diagram illustrating a touch driving circuit shown in FIGS. 1 to 3 in detail;

FIG. 8 is a diagram illustrating a part of a touch data detected and generated through a sensing circuit unit and an analog-to-digital converter of FIG. 7;

FIG. 9 is a diagram illustrating a part of a sensitivity deviation data calculated through a compensation driving controller of FIG. 7;

FIG. 10 is a diagram illustrating a part of a touch data detected and generated during a touch sensing period after the compensation of touch driving voltages;

FIG. 11 is a block diagram of an example illustrating a method of generating a sensitivity deviation data of a compensation driving controller shown in FIG. 7;

FIG. 12 is a block diagram of an electronic device according to one embodiment; and

FIG. 13 is schematic views of electronic devices according to various embodiments.

### DETAILED DESCRIPTION OF THE EMBODIMENTS

The present disclosure will now be described more fully hereinafter with reference to the accompanying drawings, in which embodiments of the disclosure are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

It will also be understood that when a layer is referred to as being "on" another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, embodiments of the present disclosure will be described with reference to the accompanying drawings.

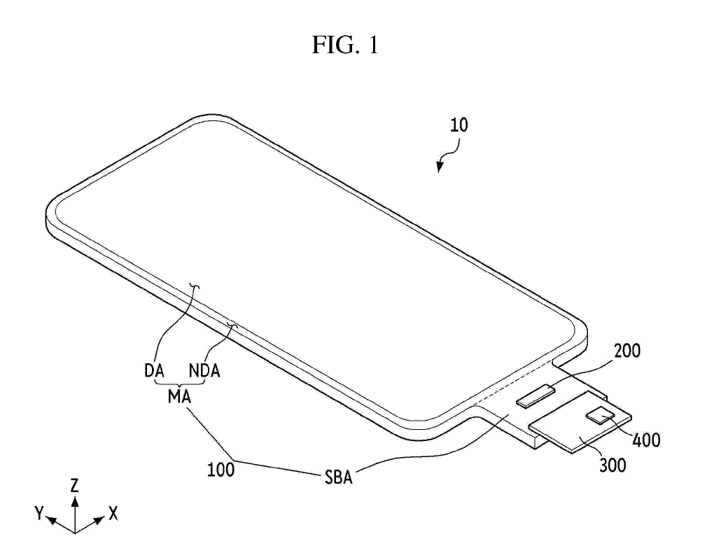

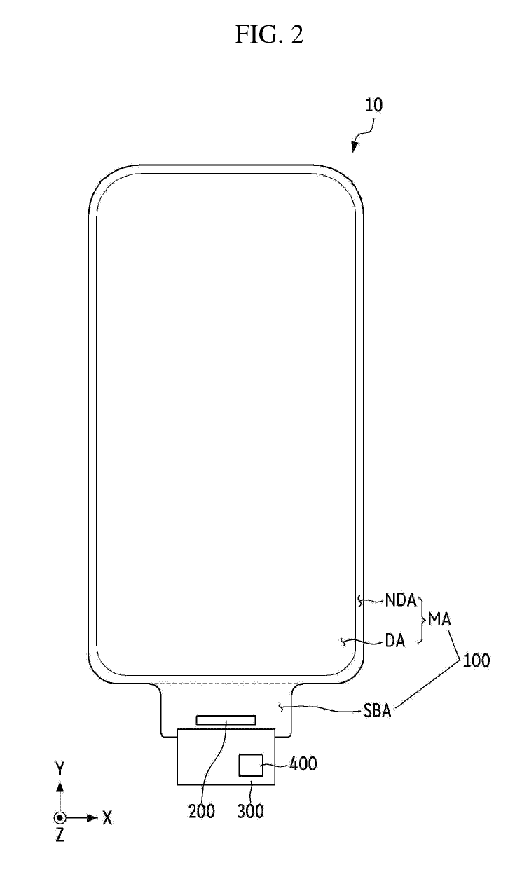

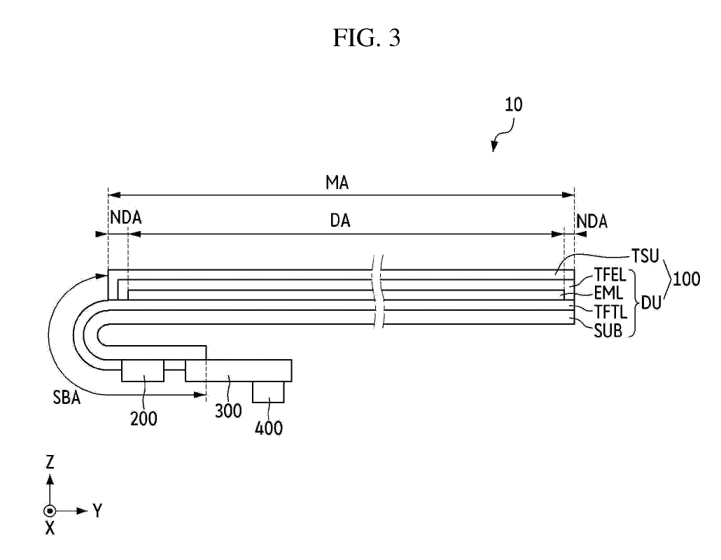

FIG. 1 is a perspective view illustrating a display device according to one embodiment of the present disclosure. In addition, FIG. 2 is a plan view illustrating a display device according to one embodiment, and FIG. 3 is a side view illustrating a display device according to one embodiment.

Referring to FIGS. 1 to 3, a display device 10 according to one embodiment may be applied to portable electronic devices such as a mobile phone, a smartphone, a tablet personal computer, a mobile communication terminal, an electronic organizer, an electronic book, a portable multimedia player (PMP), a navigation system, an ultra mobile PC (UMPC) or the like. In addition, the display device 10 according to one embodiment may be applied as a display unit of a television, a laptop, a monitor, a billboard, or an Internet-of-Things (IoT) terminal. Further, the display device 10 according to one embodiment may be applied to wearable devices such as a smart watch, a watch phone, a glasses type display, or a head mounted display (HMD). In addition, the display device 10 according to one embodiment may be applied to a dashboard of a vehicle, a center fascia of a vehicle, a center information display (CID) located on a dashboard of a vehicle, a room mirror display in place of side mirrors of a vehicle, or a display located on a rear surface of a front seat for rear seat entertainment of a vehicle.

The display device 10 according to one embodiment may be a light emitting display device such as an organic light emitting display device using an organic light emitting diode, a quantum dot light emitting display device including a quantum dot light emitting layer, an inorganic light emitting display device including an inorganic semiconductor, and a micro light emitting display device using a micro or nano light emitting diode (LED). In the following description, it is assumed that the display device 10 according to one embodiment is an organic light emitting display device, but the present disclosure is not limited thereto.

The display device 10 according to one embodiment includes a display panel 100 in which a touch sensing unit TSU is formed, a display driving circuit 200, a circuit board 300, and a touch driving circuit 400.

The display panel 100 may be formed in a rectangular shape, in plan view, having short sides in a first direction (X-axis direction) and long sides in a second direction (Y-axis direction) crossing the first direction (X-axis direction). The corner where the short side in the first direction (X-axis direction) and the long side in the second direction (Y-axis direction) meet may be rounded to have a predetermined curvature or may be right-angled. The planar shape of the display panel 100 is not limited to the rectangular shape, and may be formed in another polygonal shape, a circular shape or an elliptical shape. The display panel 100 may be formed to be flat, but is not limited thereto. For example, the display panel 100 includes a curved portion formed at left and right ends and having a constant curvature or a varying curvature. In addition, the display panel 100 may be formed flexibly so that it can be curved, bent, folded, or rolled.

The display panel 100 includes a main area MA and a sub-area SBA.

The main area MA includes a display area DA displaying an image and a non-display area NDA that is a peripheral area of the display area DA. The display area DA includes pixels for displaying an image. The sub-area SBA may protrude in the second direction (Y-axis direction) from one side of the main area MA.

It is illustrated in FIGS. 1 and 2 that the sub-area SBA is unfolded, but the sub-area SBA may be bent as illustrated in FIG. 3, and in this case, the sub-area SBA may be located on a lower surface of the display panel 100. When the sub-area SBA is bent, the sub-area SBA may overlap the main area MA in a third direction (Z-axis direction), which is a thickness direction of a substrate SUB. The display driving circuit 200 may be located in the sub-area SBA.

As illustrated in FIG. 3, the display panel 100 includes a display module DU including a substrate SUB, a thin film transistor layer TFTL, a light emitting element layer EML, and an encapsulation layer TFEL, and a touch sensing unit TSU formed on a front surface of the display module DU.

The thin film transistor layer TFTL may be located on the substrate SUB. The thin film transistor layer TFTL may be located in the main area MA and the sub-area SBA. The thin film transistor layer TFTL includes thin film transistors.

A light emitting element layer EML may be located on the thin film transistor layer TFTL. The light emitting element layer EML may be located in the display area DA of the main area MA. The light emitting element layer EML includes light emitting elements located in light emitting portions.

The encapsulation layer TFEL may be formed on the light emitting element layer EML. The encapsulation layer TFEL may be formed in the display area DA and the non-display area NDA of the main area MA. The encapsulation layer TFEL includes at least one inorganic layer and at least one organic layer for encapsulating the light emitting element layer.

The touch sensing unit TSU may be formed on the encapsulation layer TFEL or be mounted on the encapsulation layer TFEL. The touch sensing unit TSU may be formed on the display area DA of the main area MA. The touch sensing unit TSU may detect a touch of a human or an object using touch electrodes.

At least one cover window for protecting an upper portion of the display panel 100 may be located on the touch sensing unit TSU. The at least one cover window may be attached onto the touch sensing unit TSU by a transparent adhesive member such as an optically clear adhesive (OCA) film or an optically clear resin (OCR). The cover window may also be made of an inorganic material such as glass or also be made of an organic material such as plastic or a polymer material. Meanwhile, in order to prevent deterioration of visibility of an image due to reflection of external light, a polarizing layer may be additionally located between the touch sensing unit TSU and the cover window.

The display driving circuit 200 may generate signals and voltages for driving the display panel 100. The display driving circuit 200 may be formed as an integrated circuit (IC) and may be attached onto the display panel 100 in a chip on glass (COG) manner, a chip on plastic (COP) manner, or an ultrasonic bonding manner, but is not limited thereto. For example, the display driving circuit 200 may be attached onto the circuit board 300 in a chip on film (COF) method.

The circuit board 300 may be attached to one end of the sub-area SBA of the display panel 100. The display panel 100 and the display driving circuit 200 may receive digital video data, timing signals, and driving voltages from an external graphic system and the like through the circuit board 300. The circuit board 300 may be a flexible film such as a flexible printed circuit board, a printed circuit board, or a chip on film.

The touch driving circuit 400 may be located on the circuit board 300. The touch driving circuit 400 may be formed as an integrated circuit (IC) and be mounted to the circuit board 300.

The touch driving circuit 400 is electrically connected to the touch electrodes of the touch sensing unit TSU. The touch driving circuit 400 applies touch driving signals to the touch electrodes of the touch sensing unit TSU and measures the amount of change in charges of mutual capacitance for the touch nodes formed by the touch electrodes. In detail, the touch driving circuit 400 applies touch driving signals to the touch electrodes, and measures a change in capacitance of touch nodes in accordance with a change in a voltage magnitude or the amount of current of the touch sensing signal received through the touch electrodes. In this way, the touch driving circuit 400 may determine whether there is a touch (e.g., user’s touch or a user’s proximity), depending on the amount of change in charges of mutual capacitance of each of the touch nodes. A “touch,” as used herein, means that an object such as a user’s finger or an electronic pen directly contacts or otherwise activates a surface of the cover window arranged on the touch sensing unit TSU. A “proximity,” as used herein, means that an object such as a user’s finger or an electronic pen is positioned close to (hovering over) a surface of the cover window.

Meanwhile, the touch sensing unit TSU formed on the display panel 100 may have a deteriorated touch sensing performance such as deviation or distortion occurring between touch detection signals depending on usage time and usage environment. For example, the touch electrodes formed in the touch sensing unit TSU and the touch driving wires or touch sensing wires connected to each touch electrode may undergo structural changes such as corrosion or deformation depending on the time of use and usage environment.

When structural changes due to corrosion and the like occur in the touch electrodes and the touch driving wires or touch sensing wires connected to each touch electrode, a magnitude deviation in the touch sensing signals transmitted through the touch sensing wires may occur. Accordingly, the touch driving circuit 400 detects the touch sensing signals by driving the touch electrodes for a preset predetermined detection period, compares and analyzes the touch sensing signals, and generates sensitivity compensation data for each touch node to compensate for magnitude deviations in the touch sensing signals. In addition, during a touch sensing period, any change or deviation in the touch driving voltages is compensated by supplying a compensation voltage for each touch node according to the compensation value of the sensitivity compensation data.

Specifically, the touch driving circuit 400 supplies touch driving signals to each touch driving electrode through the touch driving wires for each preset predetermined detection period. Then, the touch driving circuit 400 receives touch sensing signals according to the change in mutual capacitance of each touch node from each touch sensing electrode through the touch sensing wires. Next, the touch driving circuit 400 modulates touch sensing signals received through touch sensing wires into digital data and converts the digital data into sensing data. Then, the sensing data is arranged and stored in an internal memory such as a look-up table at least in units of one frame according to an arrangement structure of the touch nodes.

The touch driving circuit 400 compares and analyzes the sensing data of each touch node among the sensing data of at least one frame unit with the average value analysis data of each frame or the peak data of other adjacent touch nodes, and generates sensitivity deviation data for each touch node according to the compared difference value. Then, the touch driving circuit 400 generates sensitivity compensation data corresponding to a magnitude inversely proportional to the sensitivity deviation magnitude for each touch node.

The touch driving circuit 400 amplifies the voltage magnitude of touch driving voltages applied to touch driving electrodes and touch driving wires corresponding to the positions of each touch node according to the compensation values of sensitivity compensation data for at least one frame, and supplies the amplified voltage magnitude to the touch driving wires.

In this way, during the predetermined detection period, the touch driving circuit 400 generates sensitivity compensation data for each touch node to compensate for the magnitude deviation of the touch sensing signals. In addition, during the touch sensing period, the voltage magnitude of the touch driving voltages applied to the touch driving electrodes and touch driving wires corresponding to the position of each touch node is compensated according to the compensation value of the sensitivity compensation data, thereby preventing a deterioration of the touch sensing performance.

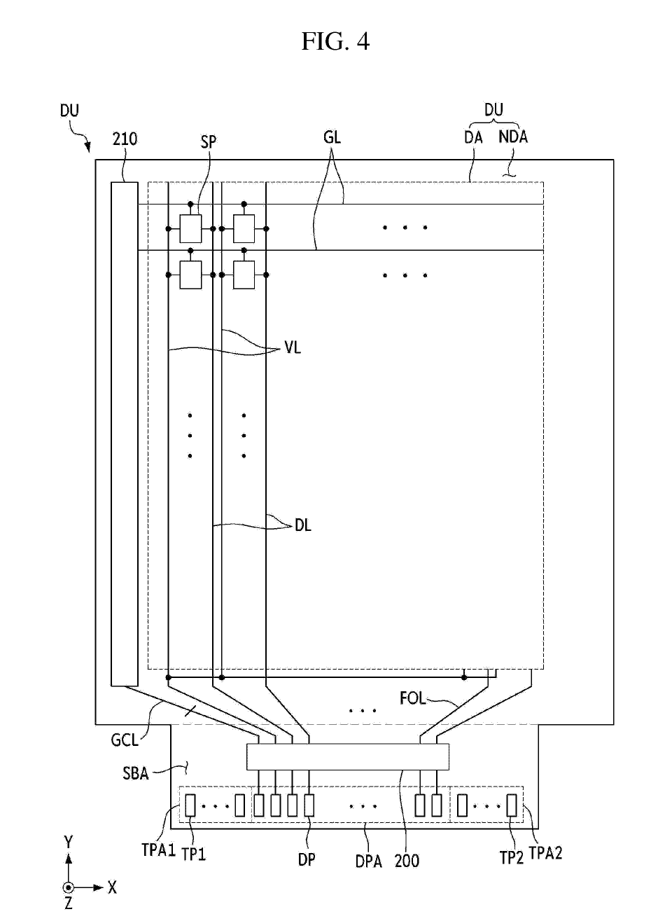

FIG. 4 is a layout view schematically illustrating an example of a layout of the display panel shown in FIGS. 1 to 3. Specifically, FIG. 4 is a layout diagram illustrating a display area DA and a non-display area NDA of a display module DU in a state before the touch sensing unit TSU is formed.

The display area DA is an area for displaying an image, and may be defined as a central area of the display panel 100. The display area DA may include a plurality of pixels SP, a plurality of gate lines GL, a plurality of data lines DL, and a plurality of power lines VL. Each of the pixels SP may be defined as a minimum unit for outputting light.

The plurality of gate lines GL may supply a gate signal received from a gate driver 210 to the plurality of pixels SP. The plurality of gate lines GL may extend in the X-axis direction, and may be spaced apart from each other in the Y-axis direction crossing the X-axis direction.

The plurality of data lines DL may supply a data voltage received from the display driving circuit 200 to the plurality of pixels SP. The plurality of data lines DL may extend in the Y-axis direction, and may be spaced apart from each other in the X-axis direction.

The plurality of power lines VL may supply a power voltage received from the display driving circuit 200 to the plurality of pixels SP. The power voltage may be at least one of a driving voltage, an initialization voltage, or a reference voltage. The plurality of power lines VL may extend in the Y-axis direction, and may be spaced apart from each other in the X-axis direction.

The non-display area NDA may surround the display area DA. The non-display area NDA may include a gate driver 210, fan-out lines FOL, and gate control lines GCL. The gate driver 210 may generate a plurality of gate signals based on a gate control signal and sequentially supply the plurality of gate signals to the plurality of gate lines GL in accordance with a set order.

The fan-out lines FOL may extend from the display driving circuit 200 to the display area DA. The fan-out lines FOL may supply the data voltage received from the display driving circuit 200 to the plurality of data lines DL.

The gate control line GCL may extend from the display driving circuit 200 to the gate driver 210. The gate control line GCL may supply the gate control signal received from the display driving circuit 200 to the gate driver 210.

The sub-area SBA may include a display driving circuit 200, a display pad area DPA, and first and second touch pad areas TPA1 and TPA2.

The display driving circuit 200 may output signals and voltages for driving the display panel 100 to the fan-out lines FOL. The display driving circuit 200 may supply the data voltage to the data line DL through the fan-out lines FOL. The data voltage may be supplied to the plurality of pixels SP, and may determine luminance of the plurality of pixels SP. The display driving circuit 200 may supply the gate control signal to the gate driver 210 through the gate control line GCL.

The display pad area DPA, the first touch pad area TPA1, and the second touch pad area TPA2 may be arranged at an edge of the sub-area SBA. The display pad area DPA, the first touch pad area TPA1, and the second touch pad area TPA2 may be electrically connected to the circuit board 300 by using an anisotropic conductive layer or a low-resistance and high reliability material such as SAP.

The display pad area DPA may include a plurality of display pad portions. The plurality of display pad portions may be connected to the display driving circuit 200 through the circuit board 300. The plurality of display pad portions may be connected to the circuit board 300 to receive digital video data, and may supply the digital video data to the display driving circuit 200.

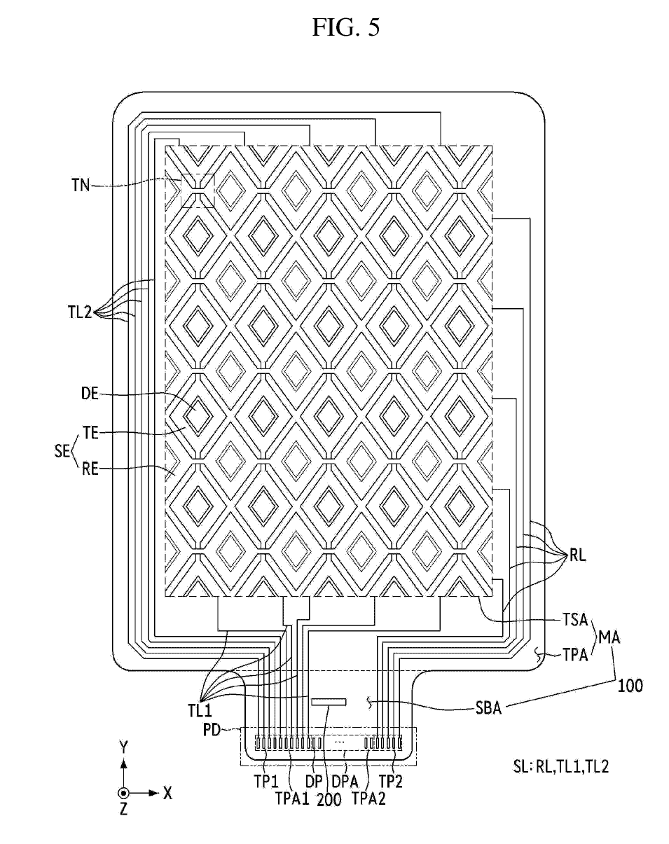

FIG. 5 is a layout view schematically illustrating an example of a touch sensing module shown in FIG. 3.

In FIG. 5, only driving electrodes TE, sensing electrodes RE, dummy patterns DE, touch lines SL, and first and second touch pads TP1 and TP2 are shown for convenience of description.

In FIG. 5, the touch electrodes SE of the main area MA include two types of electrodes, for example, driving electrodes TE and sensing electrodes RE, and are driven in a mutual capacitance manner in which the amount of change in charges of mutual capacitance of each of a plurality of touch nodes is sensed through the sensing electrodes RE after a touch driving signal is applied to the driving electrodes TE, but the present disclosure is not limited thereto.

The main area MA of the touch sensing unit TSU includes a touch sensing area TSA for sensing a touch and a touch peripheral area TPA arranged around the touch sensing area TSA. The touch sensing area TSA may overlap the display area DA of FIGS. 1 to 3, and the touch peripheral area TPA may overlap the non-display area NDA.

The driving electrodes TE, the sensing electrodes RE, and the dummy patterns DE are arranged in the touch sensing area TSA. The driving electrodes TE and the sensing electrodes RE may be electrodes for forming mutual capacitance to sense a touch of an object or a person.

The sensing electrodes RE may be arranged in parallel in the first direction (X-axis direction) and the second direction (Y-axis direction). The sensing electrodes RE may be electrically connected to each other in the first direction (X-axis direction). The sensing electrodes RE adjacent to each other in the first direction (X-axis direction) may be connected to each other. The sensing electrodes RE adjacent to each other in the second direction (Y-axis direction) may be electrically separated from each other. Accordingly, a touch node TN, in which mutual capacitance is formed, may be arranged in each of intersections of the driving electrodes TE and the sensing electrodes RE. The plurality of touch nodes TN may correspond to the intersections of the driving electrodes TE and the sensing electrodes RE.

The driving electrodes TE may be arranged in parallel in the first direction (X-axis direction) and the second direction (Y-axis direction). The driving electrodes TE adjacent to each other in the first direction (X-axis direction) may be electrically separated from each other. The driving electrodes TE may be electrically connected to each other in the second direction (Y-axis direction). The driving electrodes TE adjacent to each other in the second direction (Y-axis direction) may be connected to each other through a separate connection electrode.

Each of the dummy patterns DE may be arranged to be surrounded by the driving electrode TE or the sensing electrode RE. Each of the dummy patterns DE may be electrically separated from the driving electrode TE or the sensing electrode RE. Each of the dummy patterns DE may be arranged to be spaced apart from the driving electrode TE or the sensing electrode RE. Each of the dummy patterns DE may be electrically floated.

In FIG. 5, each of the driving electrodes TE, the sensing electrodes RE, and the dummy patterns DE has a rhombus planar shape, but is not limited thereto. For example, each of the driving electrodes TE, the sensing electrodes RE, and the dummy patterns DE may have a planar shape such as a rectangular shape other than a rhombus shape, another polygonal shape other than the rectangular shape, a circular shape or an oval shape.

The touch wires SL may be arranged in the sensor peripheral area TPA. The touch wires SL include first and second touch driving wires TL1 and TL2 connected to the driving electrodes TE, and touch sensing wires RL connected to the sensing electrodes RE.

Each of the sensing electrodes RE arranged at one end of the touch sensing area TSA may be connected to the touch sensing wires RL on a one-to-one basis. For example, among the sensing electrodes RE electrically connected in the first direction (X-axis direction) as shown in FIG. 5, each of the sensing electrodes RE arranged at the right end may be connected to each of the touch sensing wires RL. Each of the touch sensing lines RL may be connected to the second touch pads TP2 arranged on the pad portion PD on a one-to-one basis.

The driving electrodes TE arranged at one end of the touch sensing area TSA may be connected to the first touch driving wires TL1 on a one-to-one basis, and the driving electrodes TE arranged at the other end of the touch sensing area TSA may be connected to the second touch driving wires TL2 on a one-to-one basis. For example, among the driving electrodes TE electrically connected in the second direction (Y-axis direction), the driving electrodes TE arranged at the end of the lower side may be connected to the first touch driving wire TL1, respectively, and the driving electrodes TE arranged at the end of the upper side may be connected to the second touch driving wire TL2, respectively. The second touch driving wires TL2 may be connected to the driving electrodes TE at the upper side of the touch sensing area TSA by passing through the outside of a left direction of the touch sensing area TSA.

The first touch driving wires TL1 and the second touch driving wires TL2 may be connected to the first touch pads TP1 arranged on the pad portion PD on a one-to-one basis. The driving electrodes TE are connected to the first and second touch driving wires TL1 and TL2 at respective sides of the touch sensing area TSA to receive the touch driving signal. Therefore, a difference between the touch driving signal applied to the driving electrodes TE arranged at the lower side of the touch sensing area TSA and the touch driving signal applied to the driving electrodes TE arranged at the upper side of the touch sensing area TSA may be prevented from occurring due to RC delay of the touch driving signal.

When the circuit board 300 is connected to the sub-area SBA of the display panel 100, the display pad area DPA of the pad portion PD and the first and second touch pad areas TPA1 and TPA2 may correspond to pads of the display panel 100 connected to the circuit board 300. Therefore, the pads of the display panel 100 may be in contact with the display pads DP, the first touch pads TP1, and the second touch pads TP2. The display pads DP, the first touch pads TP1, and the second touch pads TP2 may be electrically connected to the pads of the circuit board 300 by using an anisotropic conductive layer or a low-resistance and high reliability material such as SAP. As a result, the display pads DP, the first touch pads TP1, and the second touch pads TP2 may be electrically connected to the touch driving circuit 400 arranged on the circuit board 300.

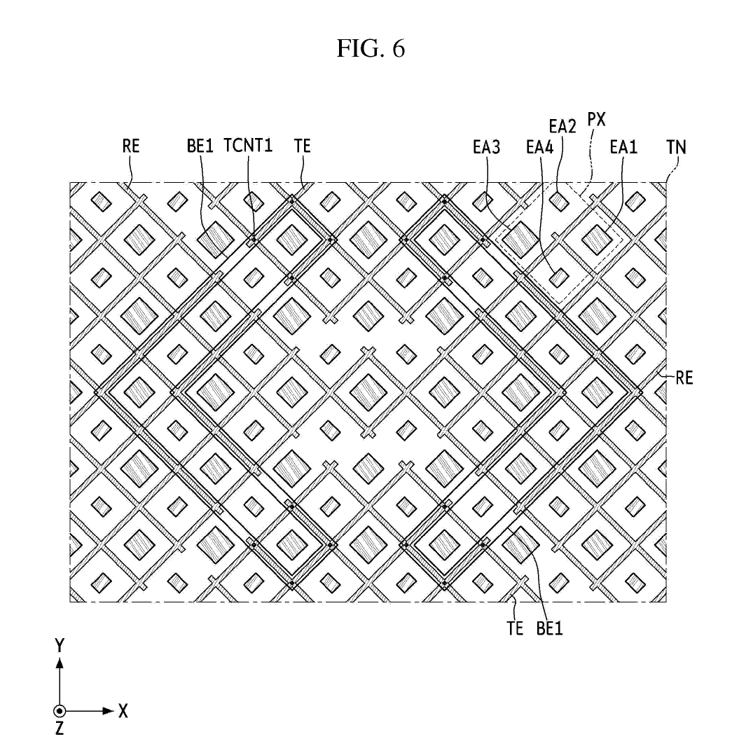

FIG. 6 is an enlarged plan view illustrating an example of a touch node shown in FIG. 5 in detail.

Referring to FIG. 6, a touch node TN of may be defined as an intersection of the driving electrode TE and the sensing electrode RE. Here, since the driving electrodes TE and the sensing electrodes RE are located on the same layer, they may be located to be apart from each other. That is, a gap may be formed between the driving electrodes TE and the sensing electrodes RE adjacent to each other.

In addition, the dummy patterns DE may also be located on the same layer as the driving electrodes TE and the sensing electrodes RE. That is to say, there may be a gap between adjacent ones of the driving electrodes TE and the dummy patterns DE and between adjacent ones of the sensing electrodes RE and the dummy patterns DE.

Connection electrodes BE1 may be located on a different layer from the driving electrodes TE and the sensing electrodes RE. Connection electrodes BE1 may be formed to be bent at least once.

Although the connection electrodes BE1 have the shape of angle brackets “<” or “>” in the example shown in FIG. 6, the shape of the connection electrodes BE1 when viewed from the top is not limited thereto. Since the driving electrodes TE adjacent to each other in the second direction (y-axis direction) are connected by the plurality of connection electrodes BE1, even if any of the connection electrodes BE1 is disconnected, the driving electrodes TE can still be stably connected with each other. Although two adjacent ones of the driving electrodes TE are connected by two connection electrodes BE1 in the example shown in FIG. 5, the number of connection electrodes BE1 is not limited to two.

The connection electrodes BE1 may overlap the driving electrodes TE adjacent to one another in the second direction (y-axis direction) in the third direction (z-axis direction), which is the thickness direction of the substrate SUB. The connection electrodes BE1 may overlap the sensing electrodes RE in the third direction (z-axis direction). One side of each of the connection electrodes BE1 may be connected to one of the driving electrodes TE adjacent to each other in the second direction (y-axis direction) through touch contact holes TCNT1. The other side of each of the connection electrodes BE1 may be connected to another one of the driving electrodes TE adjacent to each other in the second direction (y-axis direction) through touch contact holes TCNT1.

The driving electrodes TE and the sensing electrodes RE may be electrically separated from each other at their intersections by virtue of the connection electrodes BE1. Accordingly, mutual capacitance can be formed between the driving electrodes TE and the sensing electrodes RE.

Each of the driving electrodes TE, the sensing electrodes RE and the connection electrodes BE1 may form a mesh structure or a net structure when viewed from the top. In addition, the dummy patterns DE may form a mesh structure or a net structure when viewed from the top. The emission portions EA1, EA2, EA3 and EA4 of each of the pixels SP are disposed in the space portion of the mesh structure, as depicted in FIG. 6. Accordingly, the driving electrodes TE, the sensing electrodes RE, the connection electrodes BE1 and the dummy patterns DE may not overlap with the emission portions EA1, EA2, EA3 and EA4 of each of the pixels SP. Therefore, it is possible to prevent the luminance of the lights emitted from the emission portions EA1, EA2, EA3 and EA4 from being lowered, which may occur if the driving electrodes TE, the sensing electrodes RE, the connection electrodes BE1 and the dummy patterns DE cover the emission portions EA1, EA2, EA3, EA4.

Among the pixels SP in the display area DA, three or four pixels SP may be defined as unit pixels PX each capable of displaying white color. For example, a first pixel included in any one unit pixel PX includes a first emission portion EA1 emitting light of a first color, and a second pixel includes a second emission portion EA2 emitting light of a second color. In addition, a third pixel may include a third emission portion EA3 emitting light of a third color and a fourth pixel may include a fourth emission portion EA4 emitting light of a fourth color. In this case, each of the unit pixels PX may include the first emission portion EA1, the second emission portion EA2, the third emission portion EA3, and the fourth emission portion EA4. Here, the first color may be red, the second color may be green, the third color may be blue, and the fourth color may be white.

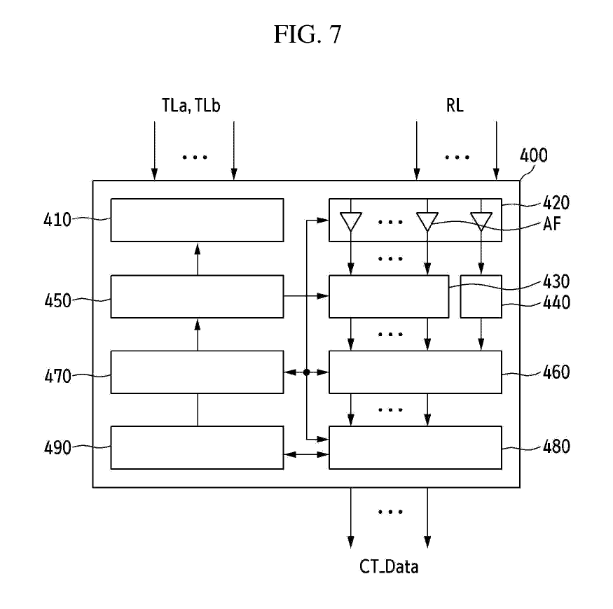

FIG. 7 is a block diagram illustrating a touch driving circuit shown in FIGS. 1 to 3 in detail.

Referring to FIG. 7, the touch driver circuit 400 includes a driving signal output unit 410, a sensing circuit unit 420, an analog-to-digital converter 430, a current detector 440, a touch driving controller 450, a coordinate data generator 460, a compensation driving controller 470, a memory 490, and a touch data output unit 480.

Under the control of the touch driving controller 450, the driving signal output 410 sequentially or selectively supplies touch driving signals to the driving electrodes TE of the touch sensing unit TSU through first and second touch driving wires TLa and TLb. At this time, the driving signal output unit 410 amplifies, reduces, or maintains the voltage magnitude of touch driving signals in response to different or identical voltage magnitudes of output control signals sequentially input from the touch driving controller 450. In addition, the touch driving signals whose voltage magnitudes are sequentially amplified, reduced, or maintained may be sequentially supplied to the driving electrodes TE through the first and second touch driving wires TLa and TLb. Here, the touch driving signals may be supplied sequentially or simultaneously to some of the selected driving electrodes TE among the entire driving electrodes TE.

The sensing circuit unit 420 senses the change in electrostatic capacity of each touch node TN by using sensing signals received from the touch sensing wires RL of the touch sensing unit TSU. For example, the sensing circuit unit 420 may receive touch driving signals fed back from the first or second touch driving wire TLa or TLb as touch sensing signals of the driving electrodes TE. Then, the touch sensing signals sensed through the sensing electrodes RE are received from the touch sensing wires RL. The sensing circuit unit 420 may use operational amplifiers AF to sense amount of change in charges of capacitance of touch nodes using touch sensing signals. The operational amplifiers AF may be connected on a one-to-one basis to feedback wires of the first or second touch driving wire TLa or TLb and the touch sensing wires RL.

The analog-to-digital converter 430 samples the voltage magnitude of the amplified sensing signals from the operational amplifiers AF of the sensing circuit unit 420, that is, the touch sensing signals according to the amount of change in charges of each touch node, and sequentially converts them into digital data which is a touch data.

The current detector 440 detects the amount of current from the amplified detection signal through the operational amplifier AF of the sensing circuit unit 420. The current detector 440 may detect the amount of current using a current detector, and the detected current amount detection value may be shared with the touch driving controller 450. The touch driving controller 450 may confirm the touch sensing operation and touch sensing period of the touch sensing unit TSU in real time based on the current amount detection value detection result.

The coordinate data generator 460 detects whether a touch has occurred by comparing and analyzing the change in the magnitude of touch data sequentially input from the analog-to-digital converter 430 with the touch data input in the preceding and following periods. Then, the touch data sequentially inputted is matched with an arrangement map of touch nodes to generate touch position coordinate data CT_Data.

The touch data output unit 480 stores the touch position coordinate data CT_Data inputted from the coordinate data generator 460 at least in one frame period unit and supplies the touch position coordinate data CT_Data to the display driving circuit 200.

The compensation driving controller 470 may generate and store sensitivity compensation data for each touch node for a preset predetermined detection period other than the touch sensing period. In addition, the compensation driving controller 470 compensates and supplies the voltage magnitude of the touch driving voltages for each touch node according to the compensation value of the sensitivity compensation data during the touch sensing period.

Specifically, the compensation driving controller 470 sequentially supplies output control signals to the driving signal output unit 410 according to the number of first and second touch driving wires TLa and TLb, that is, the number of touch driving electrodes TE, and controls touch driving signals to be supplied to the touch driving electrodes TE by the driving signal output unit 410.

The sensing circuit unit 420 receives touch sensing signals according to changes in the mutual capacitance of each touch node from the touch sensing electrodes RE, and the analog-to-digital converter 430 samples the voltage magnitude of the touch sensing signals for each touch node TN to generate touch data at least in units of one frame.

The compensation driving controller 470 selects the touch data of at least one frame unit generated in the detection period and stores the selected touch data as a sensing data in the internal memory 490 such as a look-up table. At this time, the compensation driving controller 470 may arrange and store the sensing data in the internal memory 490 such as a look-up table in units of one frame according to the arrangement structure of the touch nodes TN.

The compensation driving controller 470 compares and analyzes the sensing data for each touch node TN among the sensing data of at least one frame unit with each average value analysis data to generate sensitivity deviation data for each touch node TN according to the compared difference value. In addition, sensitivity compensation data corresponding to a magnitude inversely proportional to the sensitivity deviation magnitude of each touch node TN are generated. Here, the average value analysis data may be an average value of the sensing data of at least one frame unit.

Sensitivity deviation data for each touch node TN may be generated as a difference ratio (%) of the sensitivity value (e.g., the magnitude value of the sensing signal) for each touch node TN compared to the average value of the average value analysis data, or as an inverse substitution value, reciprocal, or inverse substitution ratio (-(%)) of the difference ratio (%). Accordingly, the sensitivity compensation data may be set as weight values corresponding to peak deviation values among the sensitivity deviation data of touch nodes TN included in vertical or horizontal lines corresponding to the touch driving electrodes TE. That is, the sensitivity compensation data may include touch driving wires TE and the weight values of the number corresponding to the number of the touch driving wires TE.

Alternatively, the compensation driving controller 470 may compare and analyze the sensing data of each touch node TN among the sensing data of at least one frame unit with the peak data of other adjacent touch nodes TN to generate sensitivity deviation data of each touch node TN according to the compared difference value. In addition, the sensitivity compensation data corresponding to a magnitude inversely proportional to the sensitivity deviation magnitude of each touch node TN may be generated. Here, the peak data of the other adjacent touch nodes TN may be any one peak value included in sensing data of the other adjacent touch nodes TN arranged adjacently in at least any one of the directions like up/down, left/right, diagonal directions and the like.

Meanwhile, the sensitivity deviation data for each touch node TN may be calculated as the difference ratio (%) of the sensitivity value (magnitude value of the sensing signal) for each touch node TN compared to any one peak value of other adjacent touch nodes TN, or may be calculated as the inverse substitution value, reciprocal, or inverse substitution ratio (-(%)) of the difference ratio (%). Accordingly, the sensitivity compensation data may be set as weight values corresponding to the peak deviation value (e.g., difference value) among the sensitivity deviation data of the touch nodes TN included in the vertical or horizontal lines corresponding to the touch driving electrodes TE. That is, the sensitivity compensation data may include touch driving wires TE and the weight values of the number corresponding to the number of the touch driving wires TE.

The touch driving controller 450 reads and stores sensitivity compensation data of at least one frame unit from the memory 490 during the standby period or touch sensing period. Then, during the touch sensing period, the weight values of the sensitivity compensation data are sequentially supplied as output control signals to the driving signal output unit 410 to correspond to the number and arrangement order of the touch driving electrodes TE and the first or second touch driving wire TLa or TLb.

The driving signal output unit 410 amplifies, reduces, or maintains the voltage magnitude of touch driving signals in response to the weight values of output control signals sequentially inputted from the touch driving controller 450 or different or identical voltage magnitudes according to the weight values. Then, the touch driving signals whose voltage magnitudes are sequentially amplified, reduced, or maintained are sequentially supplied to the driving electrodes TE through the first and second touch driving wires TLa and TLb.

As described above, the touch driving circuit 400 compensates for the voltage magnitude of touch driving voltages applied to touch driving electrodes TE and touch driving wires TLa and TLb according to the compensation value (e.g., weight value) of the sensitivity compensation data during a touch sensing period, thereby preventing a deterioration in touch sensing performance.

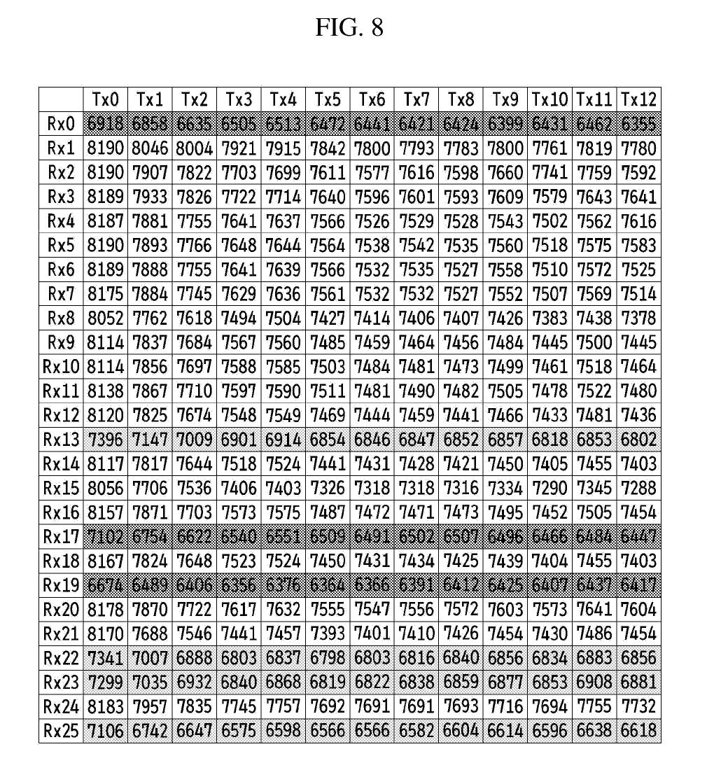

FIG. 8 is a diagram illustrating a part of a touch data detected and generated through the sensing circuit unit and the analog-to-digital converter of FIG. 7.

Referring to FIG. 8, under the control of the touch driving controller 450, the driving signal output unit 410 sequentially or selectively supplies the touch driving signals to the driving electrodes TE of the touch sensing unit TSU through the first and second touch driving wires TLa and TLb during the preset predetermined detection period.

The sensing circuit unit 420 receives the touch driving signals fed back from the first or second touch driving wire TLa or TLb as touch sensing signals of the driving electrodes TE, and also receives touch sensing signals sensed through the sensing electrodes RE from the touch sensing wires RL.

The analog-to-digital converter 430 samples the voltage magnitude of the amplified sensing signals from the operational amplifiers AF of the sensing circuit unit 420, that is, the touch sensing signals according to the amount of change in charges of each touch node, and converts them into digital data, that is, a touch data. The rows (Rx0, Rx1, Rx2, etc.) and columns (Tx0, Tx1, Tx2, etc.) indicate the position on the touch surface. In some embodiments, each cell correlates with a touch node TN. The values in the cells correlate with a property of the touch, such as the amount of force applied. Rows Rx0, Rx17, and Rx19 are highlighted because …. Rows Rx22, Rx23, and Rx25 are highlighted because….

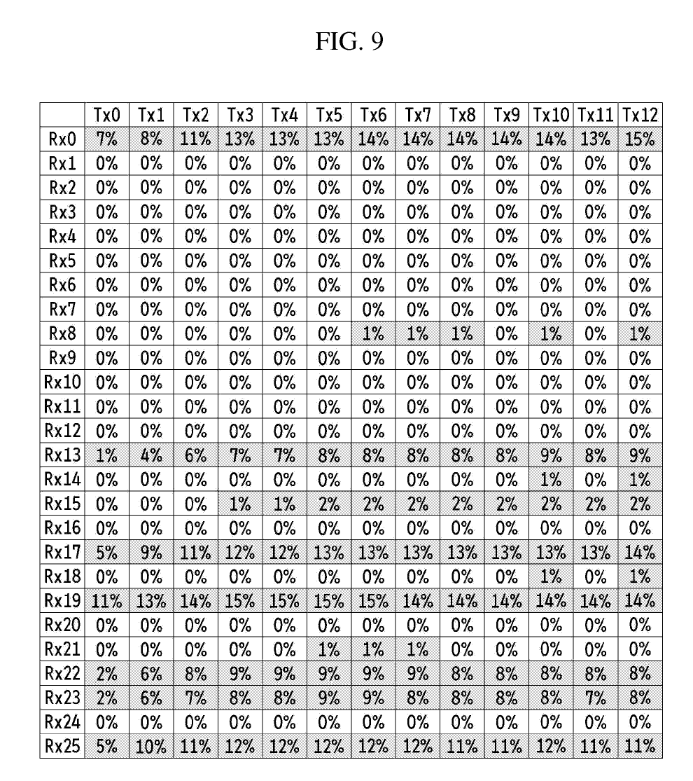

FIG. 9 is a diagram illustrating a part of a sensitivity deviation data calculated through a compensation driving controller of FIG. 7.

Referring to FIG. 9, the compensation driving controller 470 selects the touch data of at least one frame unit generated during the detection period and stores the touch data as sensing data in the internal memory 490 such as a look-up table. At this time, the compensation driving controller 470 may arrange and store the sensing data in at least one frame unit according to the arrangement structure of the touch nodes TC in the internal memory 490 such as a look-up table.

The compensation driving controller 470 compares and analyzes the sensing data for each touch node TN among the sensing data of at least one frame unit with each average value analysis data to generate sensitivity deviation data for each touch node TN according to the compared difference value. As illustrated in FIG. 9, the sensitivity deviation data of each touch node TN may be generated as a difference ratio (%) of the sensitivity value (e.g., the magnitude value of the sensing signal) for each touch node TN compared to the average value of the average value analysis data. A value of 0% indicates that there is no deviation at the corresponding touch node TN. A higher value, such as 15%, indicates that there is deviation at the corresponding touch node TN.

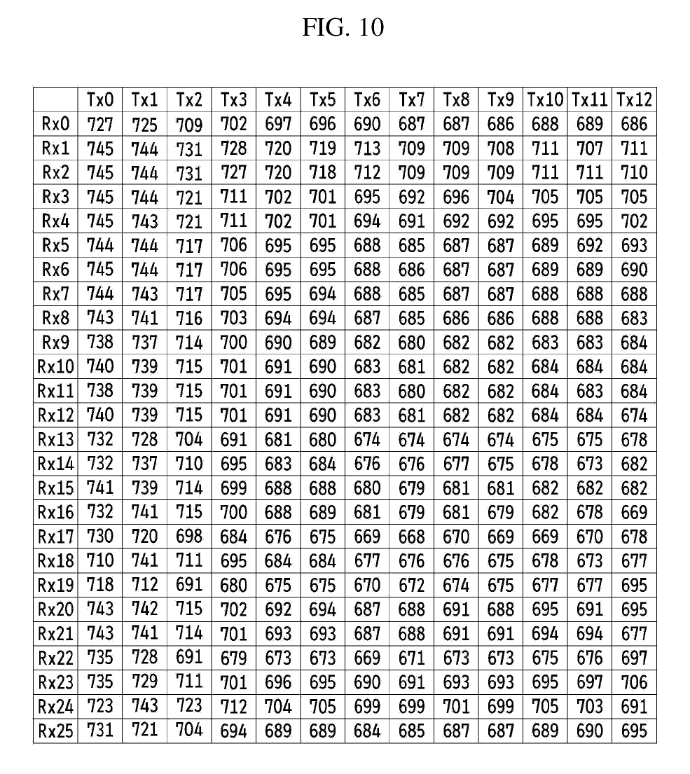

FIG. 10 is a diagram illustrating a part of a touch data detected and generated during a touch sensing period after the compensation of touch driving voltages.

Referring to FIG. 10, the sensitivity compensation data corresponding to a magnitude inversely proportional to the sensitivity deviation magnitude for each touch node TN are generated by the compensation driving controller 470. The sensitivity compensation data may be set as weight values corresponding to peak deviation values among the sensitivity deviation data of touch nodes TN included in vertical or horizontal lines corresponding to the touch driving electrodes TE. That is, the sensitivity compensation data may include touch driving wires TE and the weight values of the number corresponding to the number of the touch driving wires TE.

The touch driving controller 450 reads and stores sensitivity compensation data of at least one frame unit from the memory 490 during the standby period or touch sensing period. Then, during the touch sensing period, the weight values of the sensitivity compensation data are sequentially supplied as output control signals to the driving signal output unit 410 to correspond to the number and arrangement order of the touch driving electrodes TE and the first or second touch driving wire TLa or TLb.

The driving signal output unit 410 amplifies, reduces, or maintains the voltage magnitude of touch driving signals in response to the weight values of output control signals sequentially inputted from the touch driving controller 450 or different or identical voltage magnitudes according to the weight values. Then, the touch driving signals whose voltage magnitudes are sequentially amplified, reduced, or maintained are sequentially supplied to the driving electrodes TE through the first and second touch driving wires TLa and TLb.

As described above, the compensation driving controller 470 generates the compensation value (e.g., weight value) of sensitivity compensation data during a detection period, and thus, compensates for the voltage magnitude of the touch driving voltages applied to the touch driving electrodes TE and the touch driving wires TLa and TLb during the touch sensing period , thereby preventing a deterioration of the touch sensing performance.

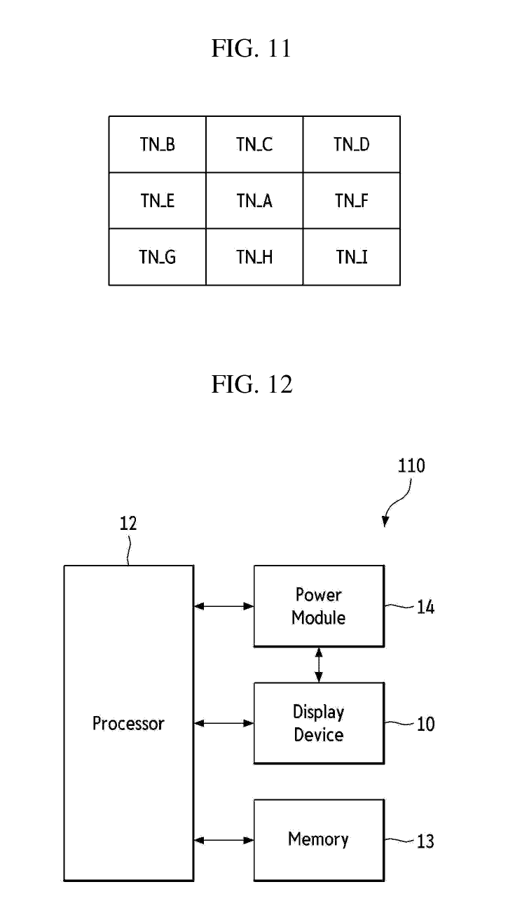

FIG. 11 is a block diagram of an example illustrating a method of generating a sensitivity deviation data of a compensation driving controller shown in FIG. 7.

Referring to FIG. 11, the compensation driving controller 470 may compare and analyze the sensing data for each touch node (e.g., TN_A) among the sensing data of at least one frame unit with the peak data of other adjacent touch nodes (e.g., TN_B to TN_I) to generate sensitivity deviation data of each touch node TN according to the compared difference value. In addition, the sensitivity compensation data corresponding to a magnitude inversely proportional to the sensitivity deviation magnitude of each touch node TN may be generated.

As described above, the sensitivity deviation data for each touch node TN may be calculated as the difference ratio (%) of the sensitivity value (magnitude value of the sensing signal) for each touch node (e.g., TN_A) compared to any one peak value of other adjacent touch nodes (e.g., TN_B to TN_I), or as the inverse substitution value or the inverse substitution ratio (-(%)) of the difference ratio (%).

Subsequently, the sensitivity compensation data may be set as weight values corresponding to the peak deviation value (e.g., difference value) among the sensitivity deviation data of the touch nodes TN included in the vertical or horizontal lines corresponding to the touch driving electrodes TE. That is, the sensitivity compensation data may include touch driving wires TE and the weight values of the number corresponding to the number of the touch driving wires TE.

The touch driving controller 450 reads and stores sensitivity compensation data of at least one frame unit from the memory 490 during the standby period or touch sensing period. Then, during the touch sensing period, the weight values of the sensitivity compensation data are sequentially supplied as output control signals to the driving signal output unit 410 to correspond to the number and arrangement order of the touch driving electrodes TE and the first or second touch driving wire TLa or TLb.

The driving signal output unit 410 amplifies, reduces, or maintains the voltage magnitude of touch driving signals in response to the weight values of output control signals sequentially inputted from the touch driving controller 450 or different or identical voltage magnitudes according to the weight values. Then, the touch driving signals whose voltage magnitudes are sequentially amplified, reduced, or maintained are sequentially supplied to the driving electrodes TE through the first and second touch driving wires TLa and TLb.

As described above, the compensation driving controller 470 generates the compensation value (e.g., weight value) of sensitivity compensation data during a detection period, and thus, compensates for the voltage magnitude of the touch driving voltages applied to the touch driving electrodes TE and the touch driving wires TLa and TLb during the touch sensing period , thereby preventing a deterioration of the touch sensing performance.

FIG. 12 is a block diagram of an electronic device according to one embodiment.

Referring to FIG. 12, an electronic device 110 according to one embodiment may include a display device 10, an image signal processor 12, a memory 13, and a power module 14.

The image signal processor 12 may include at least one of a central processing unit (CPU), an application processor (AP), a graphic processing unit (GPU), a communication processor (CP), an image signal processor (ISP), or a controller.

The memory 13 may store data information required for the operation of the image signal processor 12 or the display device 10. When the image signal processor 12 executes an application stored in the memory 13, an image data signal and/or an input control signal is transmitted to the display device 10, and the display device 10 may process the received signal and output image information through a display screen.

The power module 14 may include a power supply module, such as a power adapter or a battery device, and a power conversion module that converts power supplied by the power supply module to generate power required for the operation of the electronic device 110.

At least one of the components of the electronic device 110 described above may be included in the display device according to the embodiments described above. Further, some of individual modules functionally included in one module may be included in the display device 10 and some others may be provided separately from the display device 10. For example, the display device may include a display module, and the image signal processor 12, the memory 13, and the power module 14 may be provided in the form of other devices in the electronic device 110 other than the display device 10.

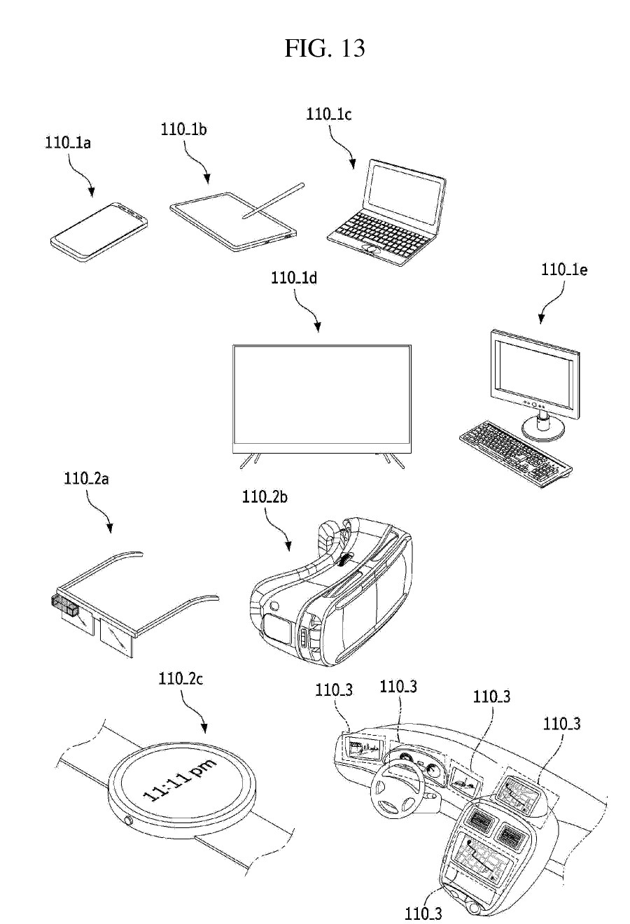

FIG. 13 is schematic views of electronic devices according to various embodiments.

Referring to FIG. 13, various electronic devices 110 to which the display devices 10 according to the embodiments are applied may include not only an image display electronic device such as a smartphone 110_1a, a tablet PC 110_1b, a laptop 110_1c, a TV 110_1d, and a desk monitor 110_1e, but also a wearable electronic device including a display module such as smart glasses 110_2a, a head mounted display 110_2b, and a smart watch 110_2c, and a vehicle electronic device 110_3 including a display module such as a room mirror display, a center information display (CID) placed on a dashboard, a center fascia, and an instrument panel of a car. In addition, the display device 10 may be applied as a display member of a television, a laptop, a monitor, a billboard, or an Internet-Of-Things (IOT).

In concluding the detailed description, a person skilled in the art will appreciate that many variations and modifications can be made to the embodiments without substantially departing from the principles of the present disclosure. Therefore, the disclosed embodiments of the disclosure are used in a generic and descriptive sense only and not for purposes of limitation.

What is claimed is:

1. A touch sensing module comprising:
a touch sensing unit in which touch electrodes are arranged in a touch sensing area; and
a touch driving circuit driving the touch electrodes during a touch sensing period to detect a touch input position and generate and output a touch position coordinate data,
wherein the touch driving circuit drives the touch electrodes during a preset detection period to detect touch sensing signals, generates sensitivity compensation data to compensate for magnitude deviation compensation of the touch sensing signals, and supplies a voltage magnitude of touch driving voltages for each touch electrode according to a compensation value of the sensitivity compensation data during the touch sensing period.

2. The touch sensing module of claim 1,
wherein the touch driving circuit supplies touch driving signals to each of touch driving electrodes among the touch electrodes through touch driving wires for each detection period, receives touch sensing signals according to a mutual capacitance of touch nodes from each touch sensing electrodes among the touch electrodes through touch sensing wires, and
converts the touch sensing signals into sensing data, and stores the sensing data in at least one frame unit according to an arrangement structure of the touch nodes in an internal memory.

3. The touch sensing module of claim 2, wherein the touch driving circuit compares and analyzes the sensing data for each touch node among the sensing data of at least one frame unit with an average value analysis data of any one frame to generate sensitivity deviation data for each touch node according to the compared difference value, and generate sensitivity compensation data corresponding to a magnitude inversely proportional to the sensitivity deviation magnitude for each touch node, and
amplify a magnitude voltage of the touch driving voltages applied to touch driving electrodes and the touch driving wires corresponding to position for each node according to a compensation value of the sensitivity compensation data and supply them to the touch driving wires.

4. The touch sensing module of claim 3,
wherein the average value analysis data is an average value of the sensing data of at least one frame unit, and
the sensitivity deviation data for each touch node is generated as a difference ratio of the sensitivity value for each touch node to the average value of the average value analysis data.

5. The touch sensing module of claim 4,
wherein the sensitivity compensation data is a weight value corresponding to a peak deviation value among the sensitivity deviation data of the touch nodes included in vertical or horizontal line each corresponding to the touch driving electrodes, and
the sensitivity compensation data includes a number of weight values corresponding to the number of touch driving wires.

6. The touch sensing module of claim 2,
wherein the touch driving circuit compares and analyzes sensing data for each touch node among the sensing data of at least one frame unit with peak data of other adjacent touch nodes to generate sensitivity deviation data for each touch node according to the compared difference value, and generate sensing compensation data corresponding to a magnitude inversely proportional to a sensitivity deviation magnitude for each touch node.

7. The touch sensing module of claim 6,
wherein a peak data of the other adjacent touch nodes is any one peak value included in sensing data of the other adjacent touch nodes arranged adjacently in at least any one of the directions among up/down, left/right, diagonal directions, and
the sensing deviation data for each touch node is calculated as a difference ratio of a sensitivity value for each touch node compared to any one peak value of the other adjacent touch nodes or generated as any one value of an inverse substitution value, reciprocal, or inverse substitution ratio of the difference ratio.

8. The touch sensing module of claim 7,
wherein the sensitivity compensation data are set as weight values corresponding to a peak deviation value among the sensitivity compensation data of touch nodes included in a vertical or horizontal line each corresponding to the touch driving electrodes, and
the sensitivity compensation data includes a number of weight values corresponding to the number of touch driving wires.

9. A display device comprising:
a display panel comprising display area in which a plurality of sub-pixels are arranged; and
a touch sensing module located on the front surface of the display panel to sense a touch,
wherein the touch sensing module comprises:
a touch sensing unit in which touch electrodes are arranged in a touch sensing area; and
a touch driving circuit driving the touch electrodes during a touch sensing period to detect a touch input position and generate and output a touch position coordinate data,
wherein the touch driving circuit drives the touch electrodes during a preset detection period to detect touch sensing signals, and generates sensitivity compensation data for each touch node to compensate for magnitude deviation of the touch sensing signals, and
supplies a voltage magnitude of touch driving voltages for each touch electrode according to a compensation value of the sensitivity compensation data during the touch sensing period.

10. The display device of claim 9,
wherein the touch driving circuit supplies touch driving signals to each of touch driving electrodes among the touch electrodes through touch driving wires for each detection period, receives touch sensing signals according to a mutual capacitance of touch nodes from each touch sensing electrodes among the touch electrodes through touch sensing wires, and
converts the touch sensing signals into sensing data, and stores the sensing data in at least one frame unit according to an arrangement structure of the touch nodes in an internal memory.

11. The display device of claim 10,
wherein the touch driving circuit compares and analyzes the sensing data for each touch node among the sensing data of at least one frame unit with an average value analysis data of any one frame to generate sensitivity deviation data for each touch node according to the compared difference value, and generate sensitivity compensation data corresponding to a magnitude inversely proportional to the sensitivity deviation magnitude for each touch node, and
amplify a magnitude voltage of the touch driving voltages applied to touch driving electrodes and the touch driving wires corresponding to position for each node according to a compensation value of the sensitivity compensation data and supply them to the touch driving wires.

12. The display device of claim 11,
wherein the average value analysis data is an average value of the sensing data of at least one frame unit, and
the sensitivity deviation data for each touch node is generated as a difference ratio of the sensitivity value for each touch node to the average value of the average value analysis data.

13. The display device of claim 12,
wherein the sensitivity compensation data is a weight value corresponding to a peak deviation value among the sensitivity deviation data of the touch nodes included in vertical or horizontal line each corresponding to the touch driving electrodes, and
the sensitivity compensation data includes a number of weight values corresponding to the number of touch driving wires.

14. The display device of claim 10,
wherein the touch driving circuit compares and analyzes sensing data for each touch node among the sensing data of at least one frame unit with peak data of other adjacent touch nodes to generate sensitivity deviation data for each touch node according to the compared difference value, and generate sensitivity compensation data corresponding to a magnitude inversely proportional to a sensitivity deviation magnitude for each touch node.

15. The display device of claim 14,
wherein a peak data of the other adjacent touch nodes is any one peak value included in sensing data of the other adjacent touch nodes arranged adjacently in at least any one of the directions among up/down, left/right, diagonal directions, and
the sensing deviation data for each touch node is calculated as a difference ratio of a sensitivity value for each touch node compared to any one peak value of the other adjacent touch nodes or generated as any one value of an inverse substitution value, reciprocal, or inverse substitution ratio of the difference ratio.

16. The display device of claim 15,
wherein the sensitivity compensation data are set as weight values corresponding to a peak deviation value among the sensitivity compensation data of touch nodes included in a vertical or horizontal line each corresponding to the touch driving electrodes, and
the sensitivity compensation data includes a number of weight values corresponding to the number of touch driving wires.

17. An electronic device comprising:
a display device displaying an image;
an image signal processor controlling an image display timing of the display device; and
a power module providing a power signal to the display device,
wherein the display device comprises:
a display panel comprising display area in which a plurality of sub-pixels are arranged; and
a touch sensing module located on the front surface of the display panel to sense a touch,
wherein the touch driving circuit comprises:
a touch sensing unit in which touch electrodes are arranged in a touch sensing area; and
a touch driving circuit driving the touch electrodes during a touch sensing period to detect a touch input position and generate and output a touch position coordinate data,
wherein the touch driving circuit drives the touch electrodes during a preset detection period to detect touch sensing signals, and generates sensitivity compensation data for each touch node to compensate for magnitude deviation of the touch sensing signals, and
supplies a voltage magnitude of touch driving voltages for each touch electrode according to a compensation value of the sensitivity compensation data during the touch sensing period.

18. The electronic device of claim 17,
wherein the touch driving circuit supplies touch driving signals to each of touch driving electrodes among the touch electrodes through touch driving wires for each detection period, receives touch sensing signals according to a mutual capacitance of touch nodes from each touch sensing electrodes among the touch electrodes through touch sensing wires, and
converts the touch sensing signals into sensing data, and stores the sensing data in at least one frame unit according to an arrangement structure of the touch nodes in an internal memory.

19. The electronic device of claim 18,
wherein the touch driving circuit compares and analyzes the sensing data for each touch node among the sensing data of at least one frame unit with an average value analysis data of any one frame to generate sensitivity deviation data for each touch node according to the compared difference value, and generate sensitivity compensation data corresponding to a magnitude inversely proportional to the sensitivity deviation magnitude for each touch node, and
amplify a magnitude voltage of the touch driving voltages applied to touch driving electrodes and the touch driving wires corresponding to position for each node according to a compensation value of the sensitivity compensation data and supply them to the touch driving wires.

20. The electronic device of claim 18,
wherein the touch driving circuit compares and analyzes sensing data for each touch node among the sensing data of at least one frame unit with peak data of other adjacent touch nodes to generate sensitivity deviation data for each touch node according to the compared difference value, and generate sensitivity compensation data corresponding to a magnitude inversely proportional to a sensitivity deviation magnitude for each touch node.
